(19) United States
(12) Patent Application Publication
(10) Pub. No.: US 2007/0094846 A1
(43) Pub. Date: May 3, 2007

(54) Hinge and hinge mounting door

(76) Inventor: Shoji Ishida, Higashiosaka-shi (JP)

Correspondence Address: THE WEBB LAW FIRM, P.C., 700 KOPPERS BUILDING, 436 SEVENTH AVENUE, PITTSBURGH, PA, 15219, US

(21) Appl. No.: 11/546,061

(22) Filed: Oct. 11, 2006

(30) Foreign Application Priority Data
Oct. 14, 2005 (JP) 2005-300538

(51) Int. Cl. E05D 7/00

(52) U.S. Cl. 16/354

(57) ABSTRACT

A hinge includes: a pair of rolling elements disposed with a distance therebetween; a movable piece that has opposite side surfaces respectively facing the pair of rolling elements so that the pair of rolling elements roll on the opposite side surfaces of the movable piece, thereby allowing the movable piece to be reciprocatingly moved; and a connection element that connects the pair of rolling elements together, while allowing the same to roll. With the hinge having the above arrangement, the pair of rolling elements, which are connected together by the connection element, move in the opposite directions while rolling on the opposite side surfaces of the movable piece, keeping the distance therebetween constant. The movable piece is also reciprocatingly moved by being pressed by the pair of rolling elements.

### CROSS REFERENCE TO RELATED APPLICATION

This application claims priority from Japanese Patent Application No. 2005-300538, which is incorporated herein by reference.

### BACKGROUND OF THE INVENTION

1. Field of the Invention

The present invention relates to a hinge for pivotal connection of a panel member and a door pivotally mounted by the hinge, and more specifically to a hinge for hinging panel members allowing the same to be folded in the opposite directions and a hinge mounting door in the form of a bifold door having two door panels that are together moved to an opening position and a closing position or in the form of a swinging door having a single door panel that is moved in the opposite directions to be opened and closed.

2. Related Art

A bifold door has two door panels that are joined together by a hinge to be opened and closed. A patent gazette of Japanese Patent No. 2728642 describes a hinge that prevents a door from accidentally pinching a finger of the user and allows a door to be tightly closed.

As illustrated in FIGS. 23 to 25, a hinge of the above type is mounted to the abutting side edges of two door panels 100, 100. Each door panel 100 has a solid panel body 101 of a rectangular shape, a frame 102 secured to a first edge (a wall), and a support column member 111 secured to a second (inner) edge.

A hinge 110 thus mounted to these door panels 100 includes spur gears 112 respectively fixedly mounted to the upper and lower ends of each of the support column members 111, and connection plates 113 for meshed engagement between a pair of the oppositely mounted spur gears 112, as illustrated in FIG. 24.

As illustrated in FIG. 25, a mounting surface of each support column member 111, to which a corresponding panel body 101 is mounted, has two vertically extending projection strips 111a, and a mounting surface of each panel body 101, to which a corresponding support column member 111 is mounted, has two vertically extending grooves 101a. The projection strips 111a are fitted in the grooves 101a, and screws are threaded into each panel body 101 through the corresponding support column member 111, thereby securing each support column member 111 to the corresponding panel body 101. With this, even in a case where the panel bodies 101 are made of wood and hence are shrunk with moisture, the respective spur gears 112 are unlikely to be twisted or the like. Thus, smooth meshing engagement therebetween is achieved.

### SUMMARY OF THE INVENTION

The hinge of the aforesaid patent document necessitates each spur gear to have an outer diameter greater than the plate thick of the panel bodies, causing the teeth of the spur gears to protrude sideward from the panel bodies, in order to allow these two panel bodies to entirely overlap each other. As a result of the exposure of the teeth of the spur gears to the outside, dusts or any foreign matters are allowed to be intruded between a pair of the oppositely mounted spur gears and hence the door panels may not be smoothly opened and closed. As another disadvantage, the spur gears are relatively poor in durability so that when they are used in a door panel of a heavy weight such as of a bifold door for a long time, causing repeated opening and closing actions, they may fatigue and hence damage.

As still another disadvantage of the hinge of the aforesaid patent document, the hinge necessitates the mounting of each support column member that is to be manufactured to have a dimension such as height and width matched to each panel body. This prevents the hinge from being used for various purposes and hence it is difficult to reduce the costs for it.

As yet another disadvantage, the two projection strips of each support column member and the two grooves of each panel body make it troublesome to manufacture the hinge of the above type and bring them into fitting engagement.

It is an object of the present invention to provide a hinge that does not protrude sidewards from a panel body when mounted, is able to be used for various purposes, and is easy to be mounted.

According to one aspect of the present invention, there is provided a hinge that includes: a pair of rolling elements disposed with a distance therebetween; a movable piece that has opposite side surfaces respectively facing the pair of rolling elements so that the pair of rolling elements roll on the opposite side surfaces of the movable piece, thereby allowing the movable piece to be reciprocatingly moved; and a connection element that connects the pair of rolling elements together, while allowing the same to roll.

With the hinge having the above arrangement, the pair of rolling elements, which are connected together by the connection element, move in the opposite directions while rolling on the opposite side surfaces of the movable piece, keeping the distance therebetween constant. The movable piece is also reciprocatingly moved by being pressed by the pair of rolling elements. The movable piece may be formed not only into a rectangular solid shape or cubic shape with the opposite side surfaces extending parallel to each other, but also a trapezoidal shape with the opposite side surfaces inwardly inclined. When the opposite side surfaces of the movable piece are formed to be extended parallel to each other, the pair of rolling elements each have a rolling section having a cylindrical shape. When the opposite side surfaces of the movable piece are formed to be inclined inwardly, the rolling section of each of the pair of rolling elements has a conical trapezoidal shape.

The pair of rolling elements with the movable piece therebetween roll on the opposite side surfaces of the movable piece. For example, when the pair of rolling elements are located close to a first end of the movable piece, a side surface of one of the rolling elements faces a side surface of the other rolling element. When the pair of rolling elements are located at the center portion on the opposite side surfaces of the movable piece, the rolling elements are both aligned in a straight line. When the pair of rolling elements are located close to a second end of the movable piece, an opposite side surface of one of the rolling elements faces an opposite side surface of the other rolling element. In other words, the rolling elements are pivotally moved by the movement of the movable piece relative to the rolling elements.

Alternatively, when the hinge has one of the rolling elements fixed in position, the movable piece is moved around this fixed rolling element, and the other rolling element is thus moved around this movable piece. In this case, the other rolling element is moved 360 degrees around the fixed rolling element via the movable piece.

For the hinge of the present invention, it is preferable to employ an arrangement, in which the opposite side surfaces of the movable piece respectively form racks thereon, and the pair of rolling elements have pinions to be respectively meshed with the racks, so that the movable piece can be reciprocatingly moved by the meshed engagement between the racks and the pinions. With the hinge having this arrangement, the rolling elements roll on the opposite side surfaces of the movable piece without slipping thanks to the meshed engagement between the racks of the movable piece and the pinions of the rolling elements, and thus the movable piece can be reciprocatingly moved without slipping along the path between the rolling elements.

For the hinge of the present invention, it is preferable to employ an arrangement, in which the connection element includes a pair of connection plates each having opposite ends protruding outwards from the opposite side surfaces of the movable piece and an intermediate portion between the opposite ends; the movable piece has plate contacting surfaces, wherein the pair of connection plates respectively contact the plate contacting surfaces of the movable piece through the intermediate portions; and a pair of pins for supporting the pair of rolling elements and connecting the pair connection plates together through the opposite ends thereof.

With the hinge having the above arrangement, the movable piece is held between the pair of connection plates. This pair of connection plates each have the intermediate portion contacting the corresponding contacting surface of the movable piece, and the opposite ends protruding outwards from the opposite side surfaces of the movable piece. The connection plates are connected together by the pins through the opposite ends of the connection plates, thereby supporting the rolling elements. Thus, the rolling elements can roll on the opposite side surfaces of the movable piece in a stabilized manner.

For the hinge of the present invention, a slidingly engaging portion is preferably formed between each of the plate contacting surfaces and a corresponding one of the connection plates. In this arrangement, the slidingly engaging portion functions not only to allow the movable piece to be moved relative to the connection element while being guided by this slidingly engaging portion, but also to allow a load applied from one of the rolling elements to the movable piece to be reduced and then applied to the other rolling element since the slidingly engaging portion serves as buffer means. Accordingly, the pinions formed on the circumferences of the rolling elements are unlikely to receive a large impact and therefore unlikely to damage.

For the hinge of the present invention, the slidingly engaging portion is preferably made up of at least one projection strip and at least one groove. In a specific arrangement, the at least one projection strip and the at least one groove are respectively formed on the movable piece and the connection plate, or vice versa.

For the hinge of the present invention, it is preferable to employ an arrangement, in which the pair of rolling elements each are made up of a rolling section that rolls on the movable piece, a support section provided at an end thereof with the rolling section, and a flange formed at a proximal end of the support section, in which the rolling section, the support section and the flange are integrally formed into a frame shape. With this hinge having the rolling elements, each having the support section provided at its end with the rolling section, the supporting sections of the rolling elements do not hit or contact each other so that the pair of rolling elements can face each other as overlapping each other. The flanges each are to secure thereto the edges of door panels or the like.

For the hinge of the present invention, it is possible to employ an arrangement, in which the pair of rolling elements each are made up of a rolling section that rolls on the movable piece, a pair of inclined plates extending in a substantially V-like shape with the rolling section serving as an apex thereof, a pair of mounting plates disposed parallel to each other with a distance being substantially equal to the length of each of the opposite side surfaces of the movable piece, wherein the rolling section, the pair of inclined plates and the pair of mounting plates are integrally formed into a frame shape.

According to the hinge having the above arrangement, in which the mounting plates are disposed with a distance substantially equal to the width of the movable piece, and the inclined plates are provided to extend in a substantially V-like shape, when the rolling elements face each other with the front surfaces or rear surfaces thereof overlapping each other, the inclined plates do not hit or contact the movable piece so that the mounting plates can overlap each other.

According to another aspect of the present invention, there is provided a door that includes any one of the hinges mentioned above, in which the pair of rotating elements are respectively secured to door panels, or a door and a doorframe. With this arrangement, the door may have door panels that are hinged together by the hinge through the respective rolling elements to provide a bifold door. Alternatively, the door may have a single door panel with the hinge having one rolling element secured to the door and the other rolling element secured to a doorframe so that the door can be pivotally moved 360 degrees around the hinge to provide a swinging door. The hinge can be secured any type of the door or doorframe and therefore can be well applied to various purposes.

The connection element preferably has a width substantially equal to or smaller than the door thickness. With this, the door, when it is a bifold door, can be opened with the respective door panels overlapping each other, and when it is a swinging door, can be opened and closed with the door panel overlapping the opposite sides of a wall of a room or the like. Also, the connection element does not protrude outwards from the surface of the door panel, since it is embedded in the door panel. Thus, it is possible to prevent dusts or the like from intruding into the inside of the hinge, while allowing a hinge mounting door to have a good appearance.

For the door of the present invention, a semi-cylindrical cover having a diameter substantially equal to the width of the rolling elements is preferably disposed on an adjacent side of the hinge so as to project towards the movable piece. The semi-cylindrical cover of this door covers a clearance between the opposite door panels or between a door panel and a doorframe. When the hinge is secured at an upper end or lower end along the door panel edge, the cover is disposed on an inner side of the hinge opposite to the upper end or lower end along the door panel edge. When the hinge is secured at an intermediate portion along the door panel edge, the cover is disposed on each of the opposite sides of the hinge along the door panel edge. The diameter of the semi-circular cover is meant a distance between the opposite ends of the cover.

It is a matter of course that plural hinges each having any one of the above arrangements can be mounted to a door.

According to the hinge of the present invention, in which the rolling elements that roll on the opposite side surfaces of the movable piece are connected together by the connecting element, the pair of the rolling elements are pivotally moved via the movable piece so that the front sides or the rear sides thereof can face each other as overlapping each other, which contributes to the improvement in convenience. This hinge is also applicable to various purposes and therefore can be manufacture in mass quantities, thus reducing the manufacturing costs.

According to the door of the present invention, in which the rolling elements of the hinge of the present invention are secured respectively to a pair of door panels, or a door panel and a frame, so that the door can be opened and closed by pushing or pulling a door panel towards either side of the door panel. This allows the user to easily pass therethrough and a door mounting work to be easily made.

### BRIEF DESCRIPTION OF THE DRAWINGS

The above, and other objects, features and advantages of the present invention will become apparent from the detailed description thereof in conjunction with the accompanying drawings wherein.

FIG. 1 is a perspective view of a door with a partially cross section, according to one embodiment of the present invention.

FIG. 2 is a plan view of a door with partially cross section, according to one embodiment of the present invention.

FIG. 3 is a plan view of a door with partially cross section, according to one embodiment of the present invention.

FIG. 4 is an exploded perspective view of a hinge with partially cross section, according to one embodiment of the present invention.

FIG. 5 is a perspective view of a hinge according to one embodiment of the present invention.

FIG. 6 is a perspective view of a hinge according to one embodiment of the present invention.

FIG. 7 is a perspective view of a hinge according to one embodiment of the present invention.

FIG. 8 is a perspective view of an enlarged essential portion of a door, according to one embodiment of the present invention.

FIG. 9 is a plan view of an enlarged essential portion of a door, according to one embodiment of the present invention.

FIG. 10 is a perspective view of an enlarged essential portion of a door, according to one embodiment of the present invention.

FIG. 11 is a plan view of an enlarged essential portion of a door, according to one embodiment of the present invention.

FIG. 12 is a perspective view of an enlarged essential portion of a door, according to one embodiment of the present invention.

FIG. 13 is a plan view of an enlarged essential portion of a door, according to one embodiment of the present invention.

FIG. 14 is a plan view of an enlarged essential portion of a door, according to one embodiment of the present invention.

FIG. 15 is a plan view of an enlarged essential portion of a door, according to one embodiment of the present invention.

FIG. 16 is an exploded perspective view of a hinge, according to another embodiment of the present invention.

FIG. 17 is a perspective view of an enlarged essential portion of a door, according to one embodiment of the present invention, in which the hinge of FIG. 16 is used.

FIG. 18 is a plan view of a door, according to one embodiment of the present invention, in which the hinge of FIG. 16 is used.

FIG. 19 is a plan view of a door, according to one embodiment of the present invention, in which the hinge of FIG. 16 is used.

FIG. 20 is a plan view of a door, according to one embodiment of the present invention, in which the hinge of FIG. 16 is used.

FIG. 21 is a plan view of a door, according to one embodiment of the present invention, in which the hinge of FIG. 16 is used.

FIG. 22 is a plan view of a door, according to one embodiment of the present invention, in which the hinge of FIG. 16 is used.

FIG. 23 is a front view illustrating a conventional door.

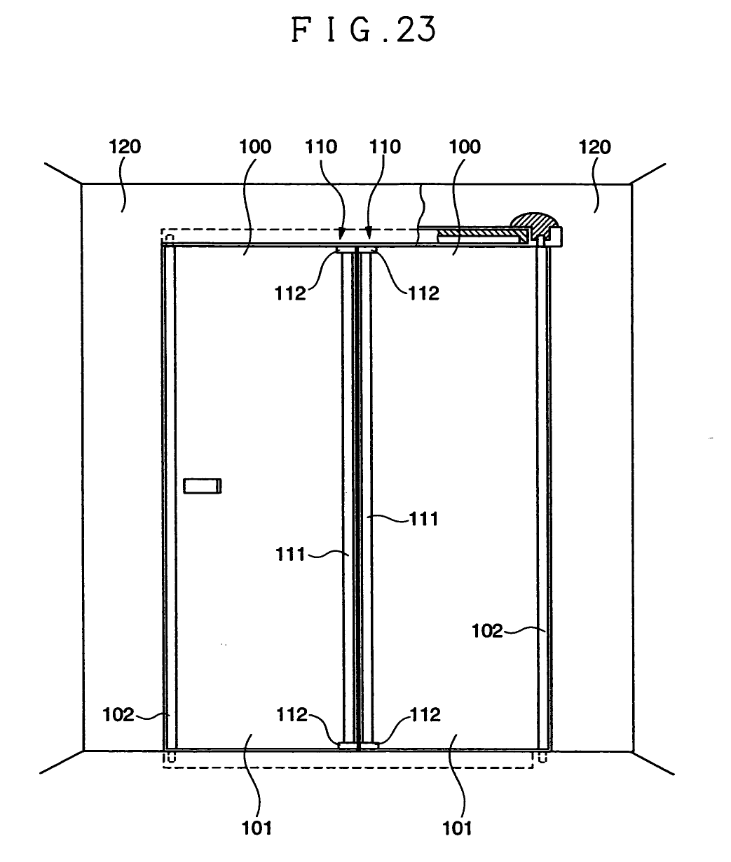

FIG. 24 is a plan view of a door having a conventional hinge with partially cross section.

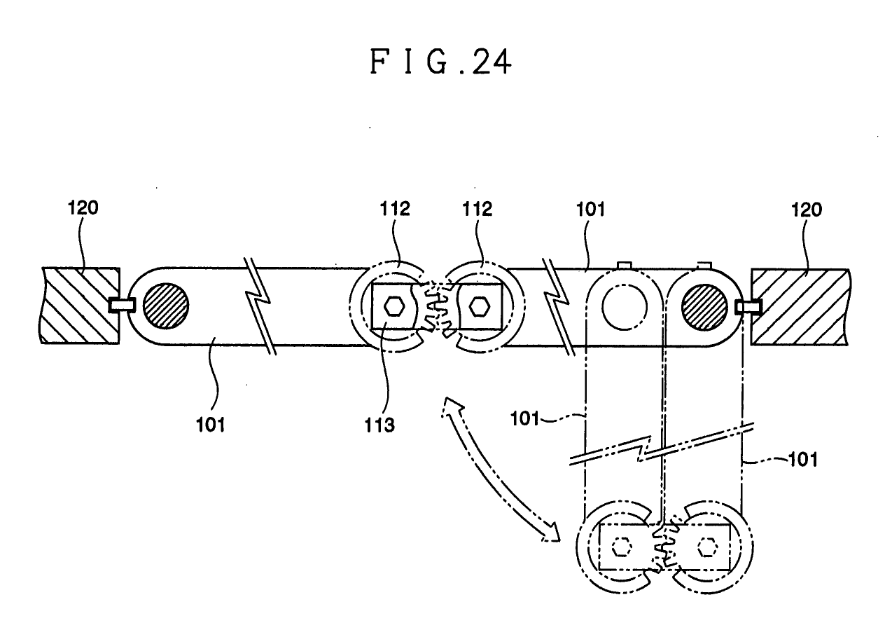

FIG. 25 is a plan view in cross section of a conventional door.

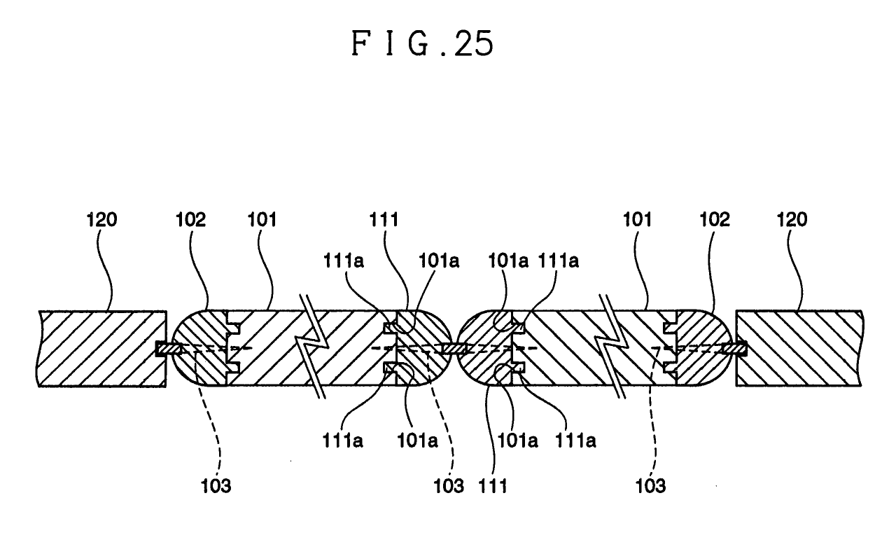

### DETAILED DESCRIPTION OF THE PREFERRED EMBODIMENT

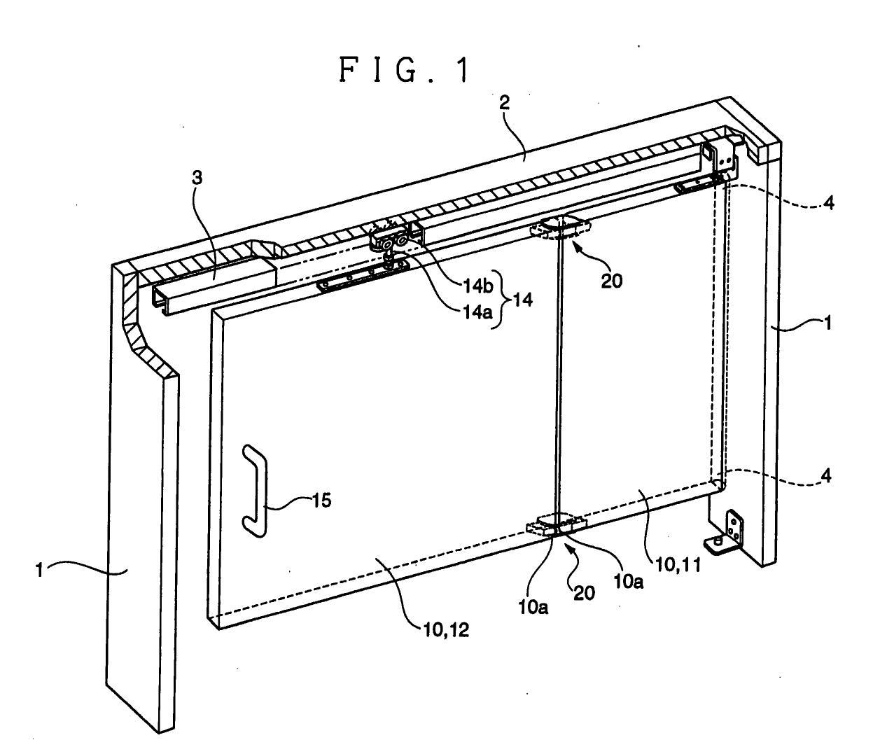

Now, the description will be made for embodiments of a hinge and a door mounted with this hinge with reference to FIGS. 1 to 15. As illustrated in FIG. 1, this door is in the form of a bifold door having two door panels 11, 12 jointed together by a hinge 20, which are disposed within an area defined by two vertical doorframes 1 and an upper doorframe 2 horizontally extending between the upper ends of the vertical doorframes 1 to be opened and closed. A suspended rail 3 is secured to a lower surface of the upper doorframe 2.

The width ratio between the door panels 11, 12 is set to be 1:2 for ease of opening and closing, and this may be varied depending on the using condition, such as 1:1. In either ratio, the door panels 11, 12 each are formed by bending a single, plate-like panel body 10 into an U-shape as viewed in plan, or arranging two panel bodies 10 in parallel to face each other, or formed by wood.

The hinges 20 are mounted at upper and lower ends of the abutting lateral edges of the door panels 11, 12. An additional hinge 20 may be mounted at a middle portion thereof. The hinges 20 at these upper and lower ends each may be mounted at a portion inward from the upper end or lower end, unlike the illustrated arrangement.

When the hinges 20 are mounted along the edges of the door panels 11, 12, a semi-cylindrical portion of each panel body 10 adjacent to each hinge 20 serves as a cover 10a for protection of the hinge 20 from an external force or the like. When the hinge 20 is mounted at a middle portion along the edges of the door panels 11, 12, the cover 10a may be disposed on both the upper and lower sides of the hinge 20. When the door panels 11, 12 each are made of a single wood panel, each cover 10a having a semi-cylindrical shape is separately prepared and attached to the corresponding abutting edge of each wood panel.

The door panel 11 having a small width (hereinafter referred to “small door panel”) is swingably supported through its proximal edge by a vertical doorframe 1 (first vertical doorframe 1) by support members 4. The door panel 12 having a large width (hereinafter referred to “large door panel”) is suspended by the suspended rail 3 with a suspending wheel mounted at a substantially lengthwise center of the upper edge of the large door panel 12. The suspending carriage 14 has a shaft 14a secured to the upper edge of the large door panel 12 and rollers 14b rotatably mounted to an upper end of the shaft 14a.

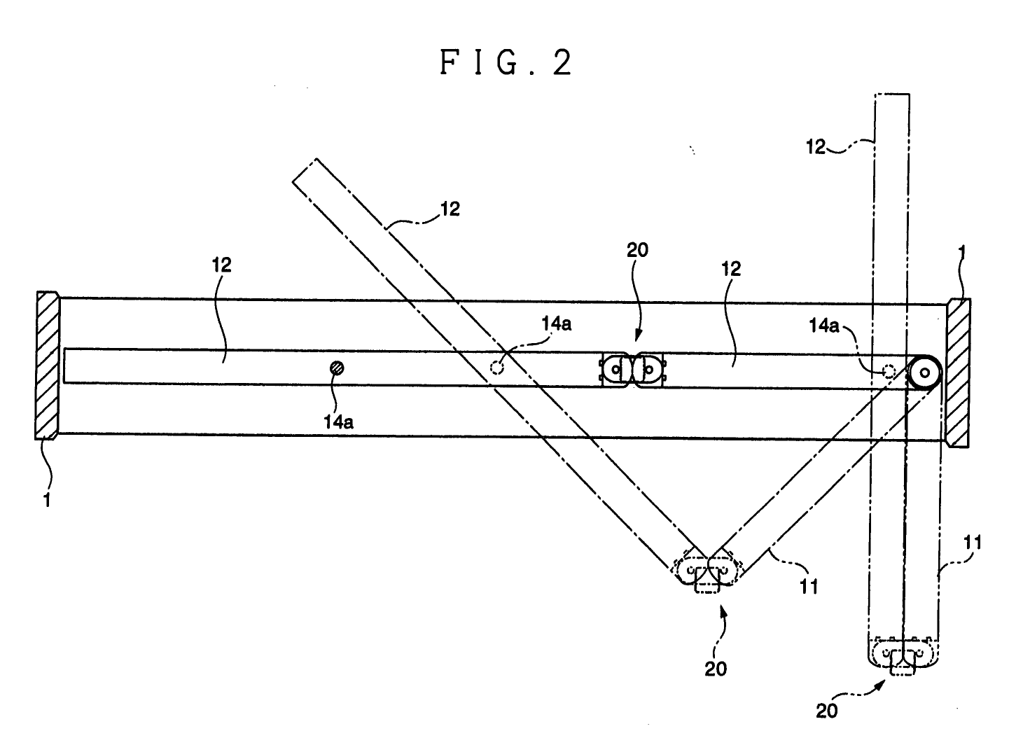

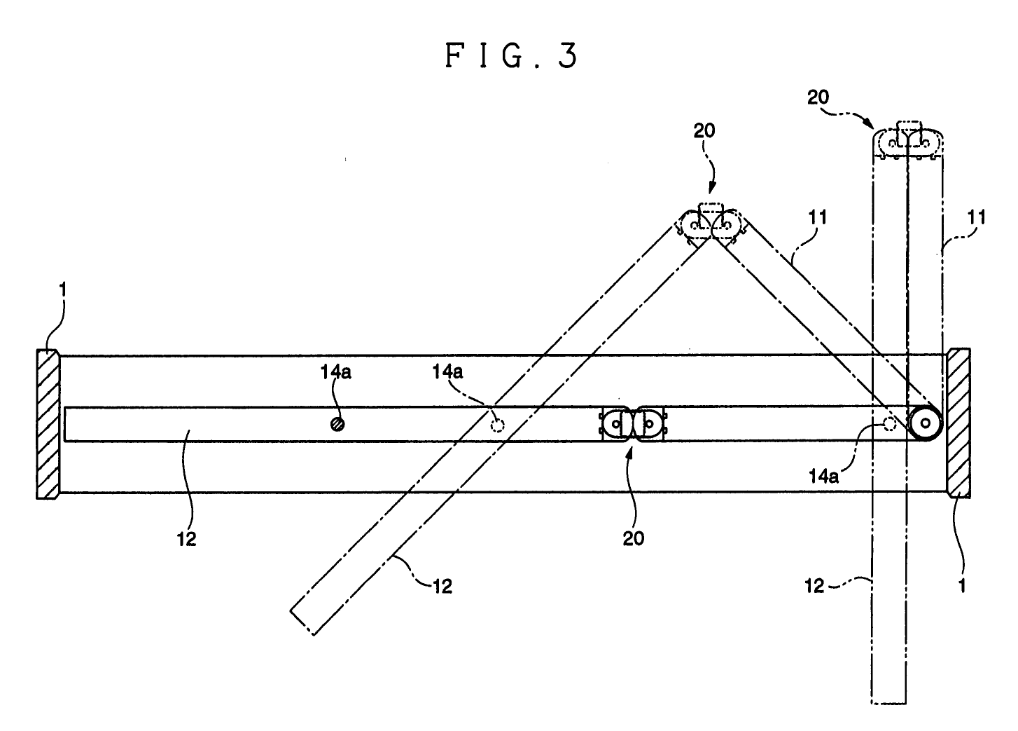

A handle 15 is attached to the large door panel 12. When this handle 15 is pushed or pulled, the large door panel 12 is moved as being tilted as viewed in plan, thus pressing the small door panel 11, with the shaft 14a of the suspending carriage 14 serving as the rotational axis, as illustrated in FIGS. 2 and 3. The pushed small door panel 11 is tilted towards the same side as the large door panel 12 as viewed in plan. When the door is completely opened, the large door panel 12 and the small door panel 11 overlap each other on the side of the first vertical doorframe 1.

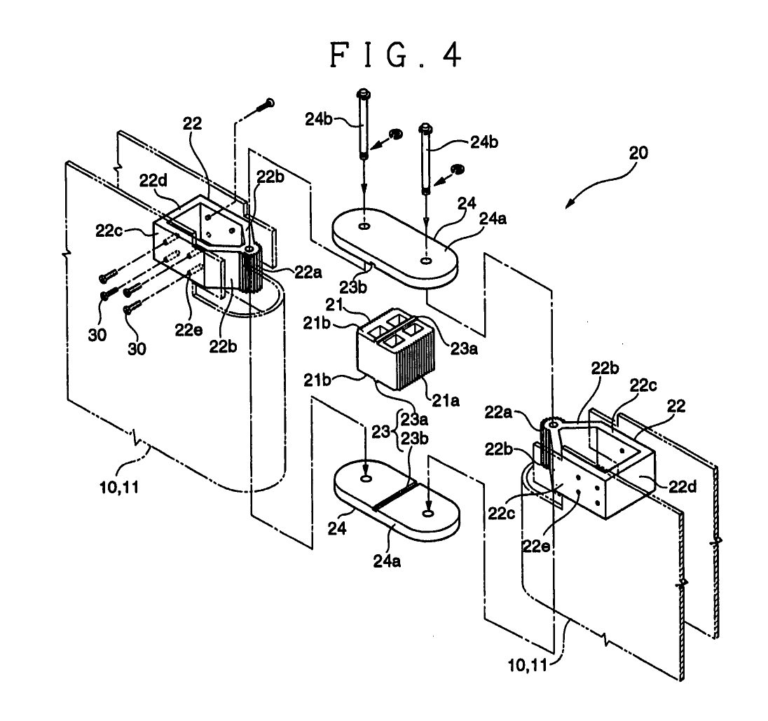

For the opening and closing of these door panels 11, 12, the hinges 20 mounted thereto each have a movable piece 21, rolling elements 22 and a connection element 24, as illustrated in FIGS. 4 to 7.

The movable piece 21 has a rectangular solid shape or cubic shape with opposite side surfaces 21 parallel to each other and opposite contacting surfaces 21b (upper and lower side surfaces in Figures) parallel to each other, or a trapezoidal shape with the opposite side surfaces 21a inwardly inclined and the opposite contacting surfaces 21b parallel to each other. Racks are formed on the opposite side surfaces 21a.

A pair of the rolling elements 22 are disposed on the opposite sides of the movable piece 21, each having a semi-cylindrical rolling section 22a that moves in the opposite directions while rolling on the corresponding side surface 2 la of the movable piece 21, a pair of inclined plates 22b extending in a substantially V-like shape with the rolling section 22a serving as an apex thereof, a pair of mounting plates 22c disposed on the proximal ends of the respective inclined plates 22b to be parallel each other, and an end plate 22d extending between the proximal ends of the mounting plates 22c, thus forming a pentagonal frame shape.

The distance between the parallel mounting plates 22c is substantially equal to the length of each side surface 21a, or the length of the movable piece 21. Four small holes 22e are formed in each of the mounting plates 22c to fixedly mount the corresponding panel body 10 thereto. These small halls 22e may be formed at three, or five or more portions of each mounting plate 22c.

On the circumference of each rolling section 22a is formed a pinion that is to be meshed with the corresponding rack of the movable piece 21. A through-hole is formed along the center axis of the rolling section 22a. When the movable piece 21 has a trapezoidal shape, the rolling section 22a has a conical trapezoidal shape like a bevel gear.

The connection element 24 is to connect the rolling sections 22a together while allowing the same to roll, and has intermediate portions respectively contacting the opposite contacting surfaces 21b of the movable piece 21, a pair of connection plates 24a each having opposite ends protruding outwards from the opposite side surfaces 21a of the movable piece 21, each plate having a running track shape, and pins 24b inserted in the through-holes of the rolling sections 22a through the opposite ends of the connection plates 24a. Thus, the connection plates 24a each have a length longer than the distance between the pair of the rolling sections 22a that hold the movable piece 21 therebetween. For the pins 24b that extend through the through-holes of the rolling sections 22a, two pins may be provided for each side of the connection plates 24a so that they are only inserted up to portions inward from the corresponding ends of the through-holes of the rolling sections 22a, or partially inserted into the through-holes.

Slidingly engaging portions 23 are respectively formed between the contacting surfaces 21b of the movable piece 21 and the connection plates 24a. Each engaging portion 23 is made up of, for example, a projection strip 23a formed on each of the contacting surfaces 2 lb of the movable piece 21 and a groove 23b formed in the corresponding connection plate 24a for fittingly receiving the projection strip 23a. This arrangement may be reversed. That is, the groove 23b is formed in each of the contacting surfaces 2 lb of the movable piece 21 and the projection strip 23a is formed on the corresponding connection plate 24a. In either arrangement, the single or plural slidingly engaging portions each comprising the projection strip 23a and the groove 23b are formed on each side of the movable piece 21 along the center line or line or lines parallel to the center line of the contacting surfaces 21b of the movable piece 21.

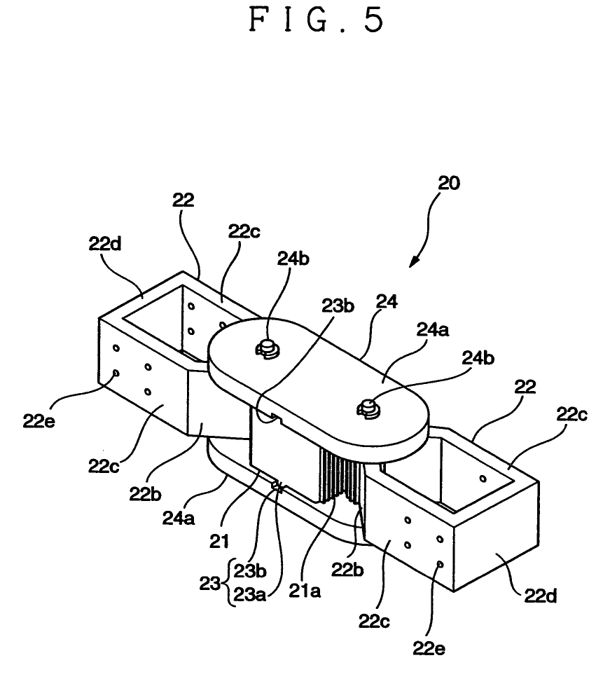

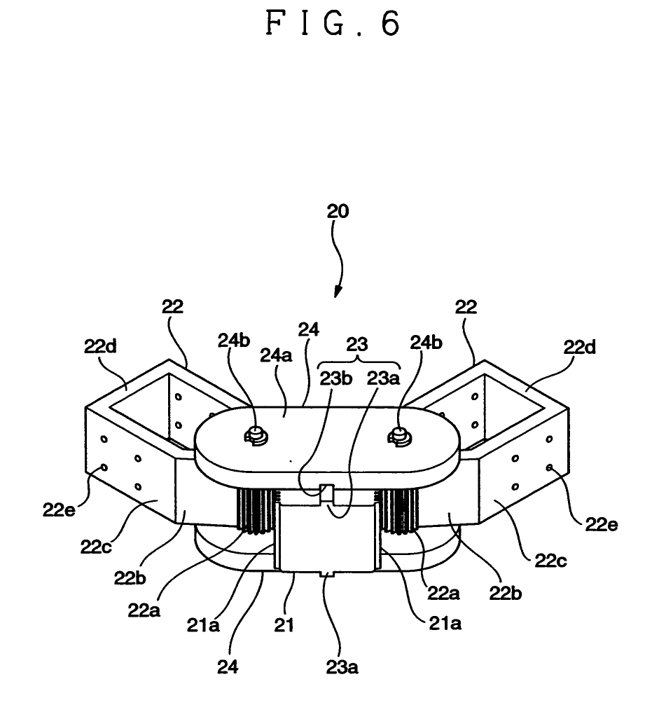

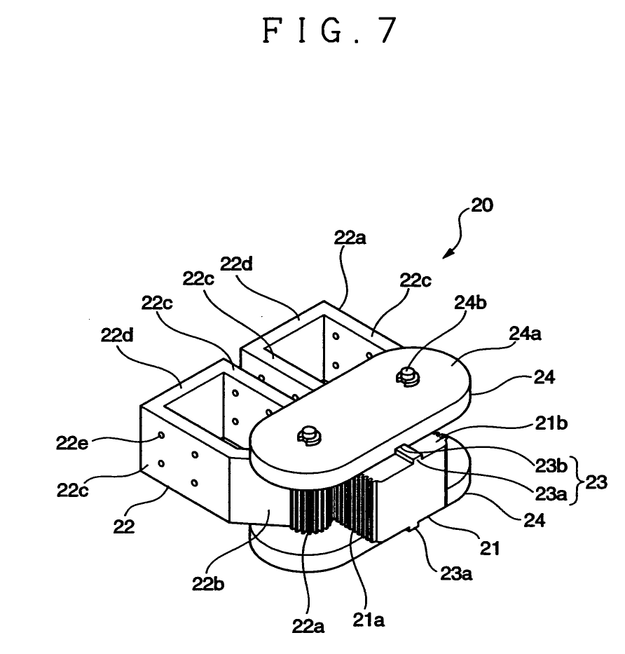

According to the thus structured hinge 20 of this embodiment, the two rolling elements 22 aligned in a straight line as illustrated in FIG. 5 are pivotally moved as illustrated in FIG. 6, in which the two rolling elements 22 are positioned at an angle to one another with the movable piece 21 as a pivotal center, and then finally have their positioned changed, in which the two rolling elements 22 are positioned adjacent to each other, as illustrated in FIG. 7.

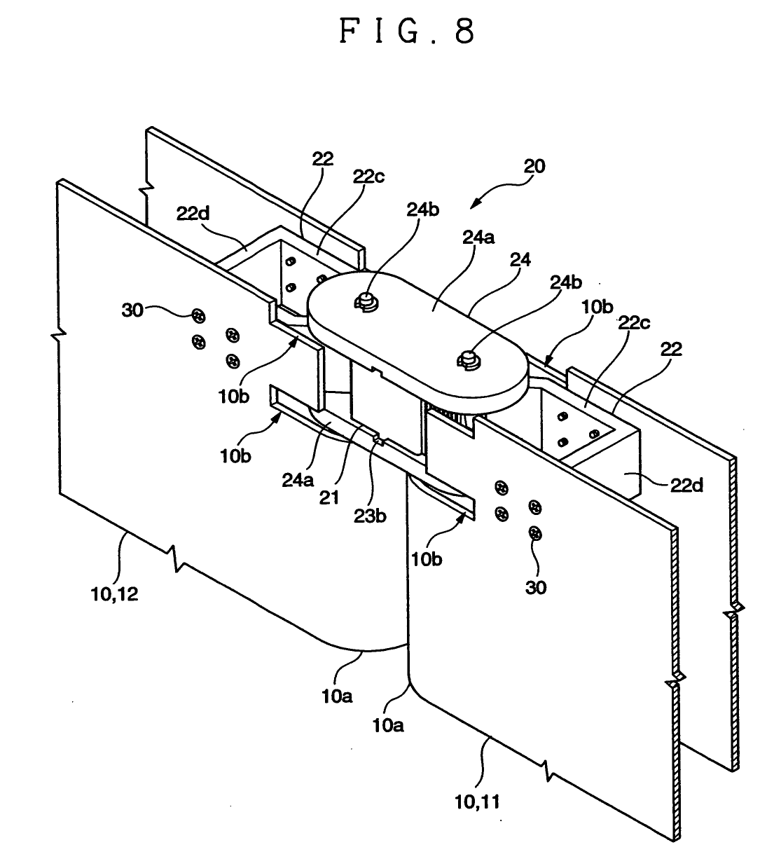

Now, the description will be made for a door such as a bifold door having the small door panel 11 jointed to the large door panel 12 by the hinges 20, with reference to FIGS. 8 to 15. The panel bodies 10 respectively forming the small door panel 11 and the large door panel 12 have cutouts 10b for receiving the connection plates 24a. The panel bodies 10 further have small holes in communication with the small holes 22e formed in the mounting plates 22c, through which countersunk screws 30 are threaded so that the panel bodies 10 are secured to the mounting plates 22c. The semi-cylindrical covers 10a of the panel bodies 10 each have a diameter, or a distance between the opposite ends of the arc substantially equal to the width of the mounting plates 22c of the rolling elements 22, and each are disposed adjacent to the corresponding side of each hinge 20 with the center of the cover 10a positioned coaxial with the corresponding rolling section 22a.

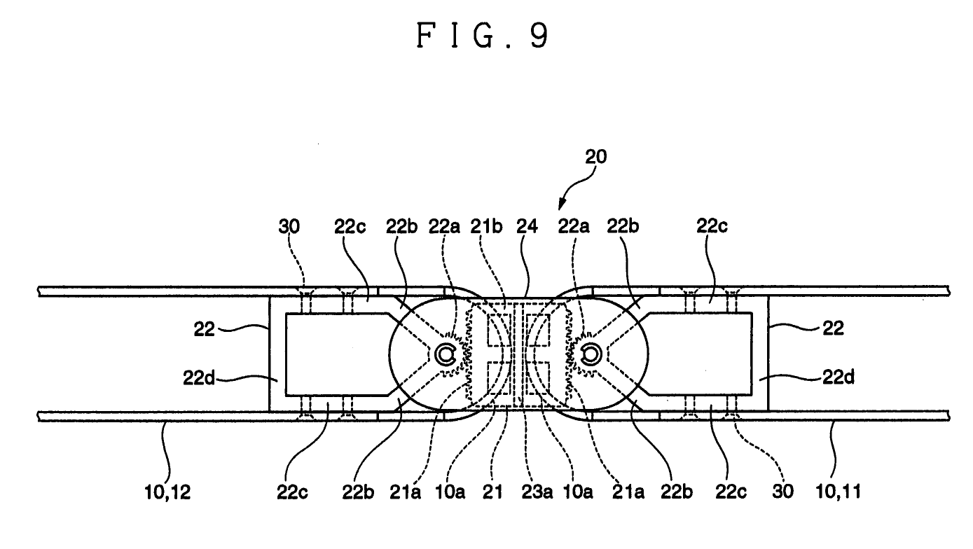

When the door panels 11, 12 jointed by the hinges 20 are at the closed positions, the pair of the rolling elements 22 and the movable piece 21 are aligned in a single line, as illustrated in FIGS. 8 and 9. The rolling sections 22a of the rolling elements 22 each are positioned at the center of the corresponding side surface 21a of the movable piece 21. At this position, the covers 10a of the panel bodies 10 face each other, causing almost no clearance between the door panels 11, 12.

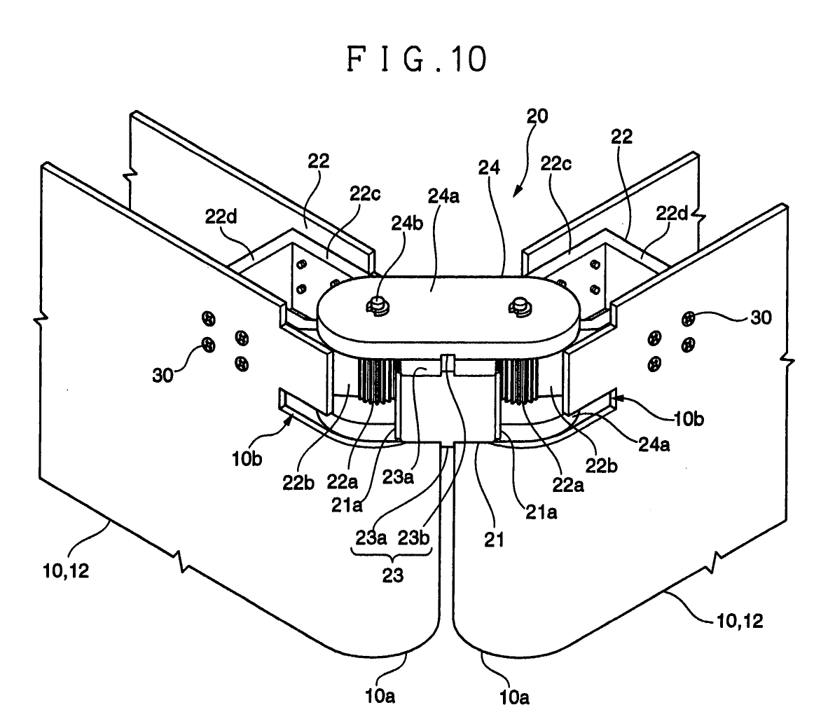

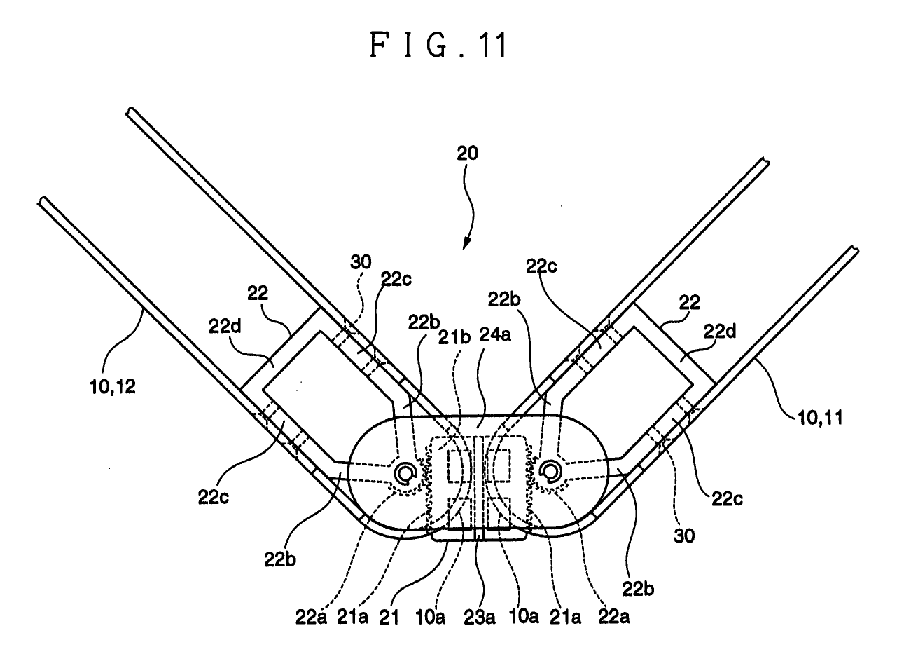

When pushing the handle 15 mounted to the large door panel 12 for opening the door, the large door panel 12 is moved towards the first vertical doorframe 1 while being tilted in the clockwise direction in dashed line in FIG. 2, and in FIGS. 10 and 11, about the shaft 14a of the suspending carriage 14. At this moment, the rolling section 22a of one of the rolling elements 22 (first rolling element 22) in each hinge, to which the large door panel 12 is secured, rolls on the corresponding side surface 21a of the movable piece 21 from the center towards a first end so that the movable piece 21 is moved.

The movement of the movable piece 21 causes the rolling section 22a of the other rolling element 22 (second rolling element 22) to roll on the corresponding side surface 2 la of the movable piece 21 from the center to a first end. Accordingly, the second rolling element 22 is tilted in the anti-clockwise direction as illustrated in Figures so that the small door panel 11 is tilted in the anti-clockwise direction as viewed in Figures about the support members 4 mounted to the first vertical doorframe 1.

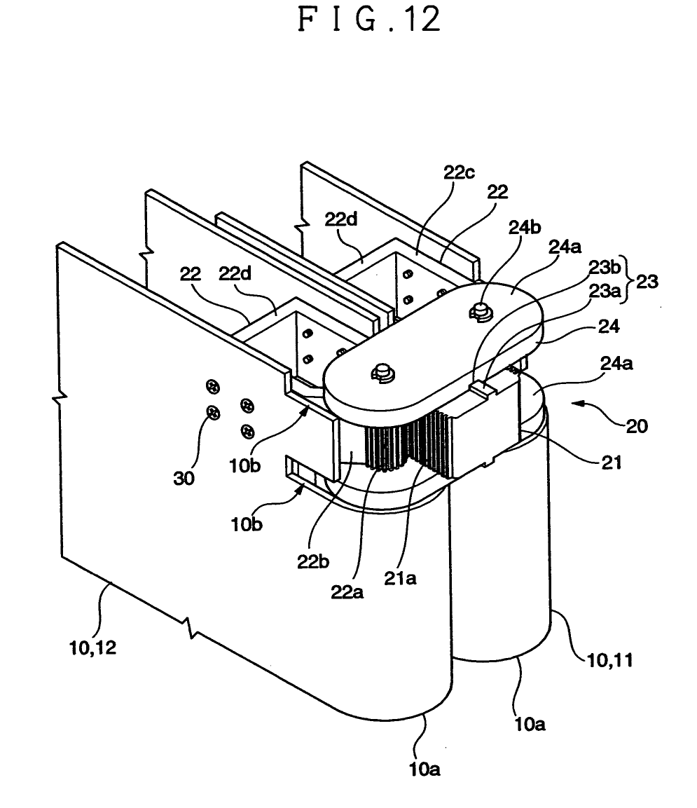

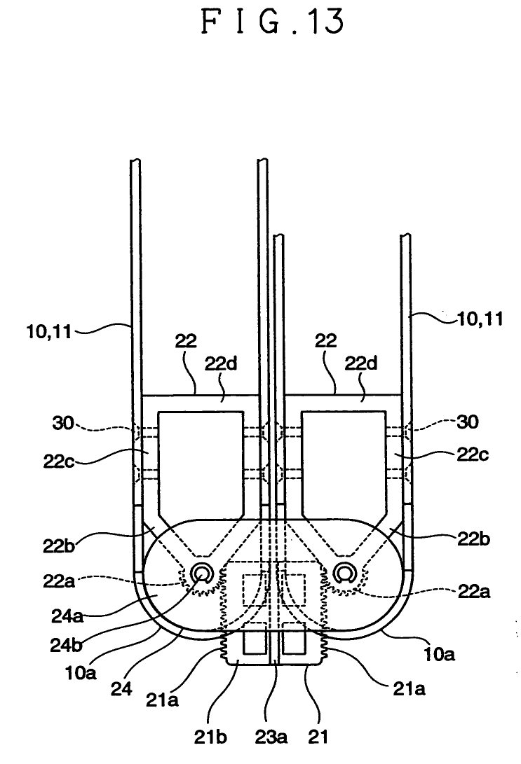

Thus, the large door panel 12 and the small door panel 11 hinged together by the pair of the rolling elements 22 in each hinge are bent as illustrated in dashed line in FIG. 2, and FIGS. 10 and 11, and move close to the first vertical doorframe 1. When the handle 15 is pushed, the large door panel 12 and the small door panel 11 overlap each other, as illustrated in dashed line in FIG. 2, and FIGS. 12 and 13, so that the door is completely opened.

On the other hand, when the door is to be closed, the handle 15 mounted to the large door panel 12 is pulled, so that the rolling section 22a of the first rolling element 22, to which the large door panel 12 is secured, rolls on the corresponding side surface 21a of the movable piece 21 from the first end to the center. At the same time, the rolling section 22a of the second rolling element 22, to which the small door panel 11 is secured, rolls on the corresponding side surface 21a of the movable piece 21 from the first end to the center. Thus, the large door panel 12 and the small door panel 11 hinged together by the pair of the rolling elements 22 in each hinge are brought from the bending position as illustrated in dashed line in FIG. 2 to a straight position as illustrated in solid line in FIG. 2, so that the door is closed.

In this series of action, the racks formed on the side surfaces 2 la of the movable piece 21 and the pinion formed on the circumferences of the rolling sections 22a of the rolling elements 22 are held in meshed engagement with each other, so that the rolling sections 22a smoothly roll on the movable piece 21 without slipping and hence the small door panel 11 and the large door panel 12 are smoothly opened and closed.

As an additional advantage, a load applied to the movable piece 21 from the rolling section 22a of the first rolling element 22 is applied to the second rolling element 22 after the load is reduced by the slidingly engaging portions 23 that serve as buffer means. Specifically, the projection strips 23a formed on the opposite contacting surfaces 2 lb of the movable piece 21 are fitted in the grooves 24c formed in the connection plates 24a of the connection element 24, so that a load from the first rolling element 22 is also applied to the connection element 2, and hence the load, after it is reduced, is applied to the second rolling element 22. Therefore, even after the repeated opening and closing of the door for a prolonged period of time, the racks and the pinions are unlikely to be damaged.

This door can be opened also by pulling the handle 15. Specifically, as illustrated in dashed line in FIG. 3, when the handle 15 is pulled, the large door panel 12 is moved towards the first vertical doorframe 1 while being tilted in the anti-clockwise direction in Figures with the shaft of the suspending carriage 14 serving as the rotational axis. At this moment, the rolling section 22a of the first rolling element 22, to which the large door panel 12 is secured, rolls on the corresponding side surface 21a of the movable piece 21 from the center towards a second end, so that the movable piece 21 is moved.

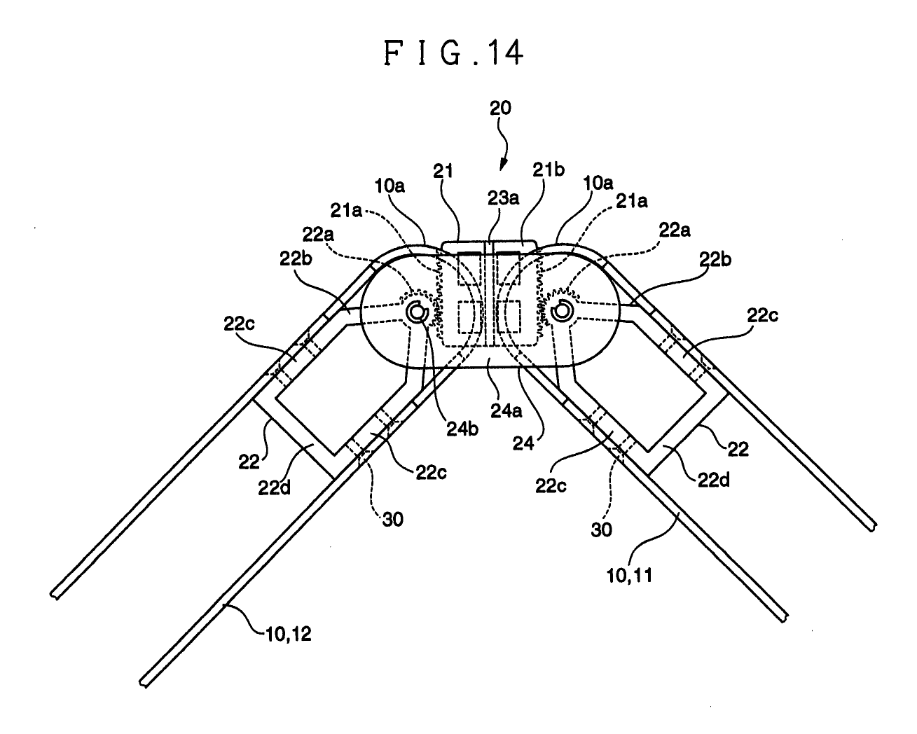

The movement of the movable piece 21 causes the rolling section 22a of the second rolling element 22 to roll on the corresponding side surface 21a of the movable piece 21 from the center towards a second end. Accordingly, the second rolling element 22 having this rolling section 22a is tilted in the clockwise direction as viewed in the drawings, as illustrated in FIG. 14, while the small door panel 11 is tilted in the clockwise direction as viewed in the drawing with the support members 4 mounted to the first vertical doorframe 1 serving as the rotational axis.

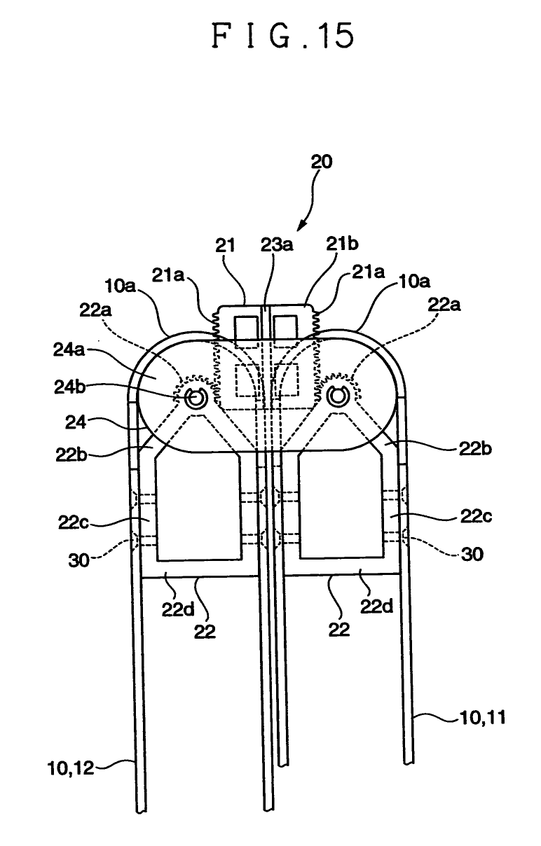

When the handle 15 is further pulled, the large door panel 12 and the small door panel 11 hinged together by the pair of the rolling elements 22 overlap each other as illustrated in dashed line in FIG. 3 and FIG. 15, so that the door is opened. By pushing the handle 15, the hinges 20 are moved in the direction opposite to the direction of the above operation so that the door can be closed.

Thus, the door of this embodiment can be opened and closed by moving the door panels in the opposite directions. In addition, the large door panel 12 and the small door panel 11 can completely overlap each other. When the door is used, for example, for a small bathroom of the hospital or other facility, it is possible to provide a space making it possible to rescue a person who fell from a wheel chair in the bathroom.

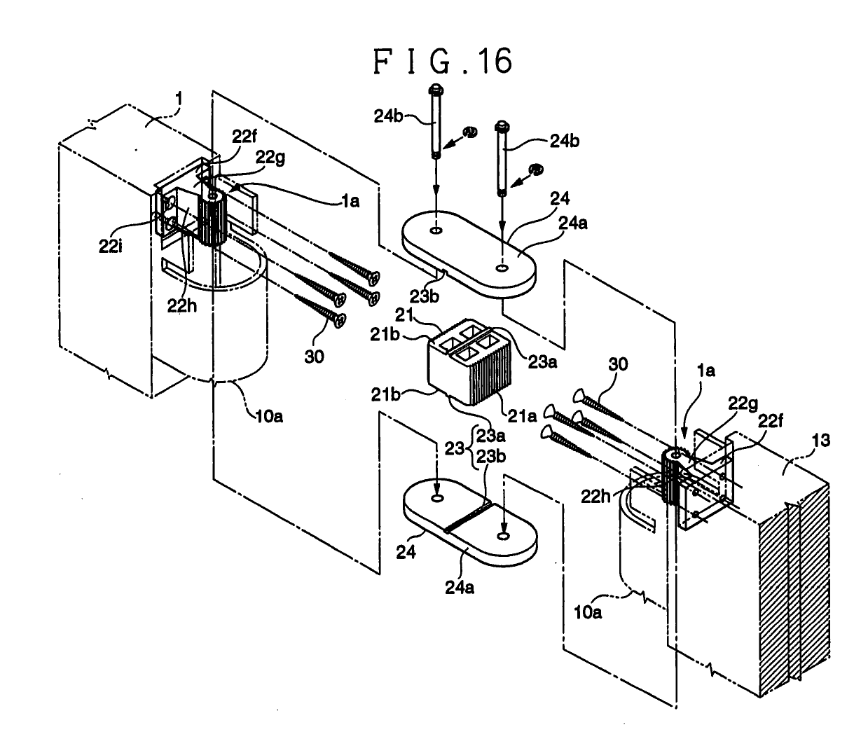

Now, the description will be made for another embodiment of the hinge of the present invention, with reference to FIG. 16. The hinge 20 of this embodiment has the rolling elements 22, each made up of a flange 22f and a support section 22g integrally formed together forming a T-like shape, with the corresponding rolling section 22a provided at an end of the support section 22g. It is to be noted that, according to the mounting condition of the hinge 20, the flange 22f and the support section 22g may be integrally formed into an L-like shape. In either arrangement, the flange 22f is preferably connected to the support section 22g by a rib 22h. The flange 22f has countersink holes 22i (four are illustrated, while no limitation is intended to the number) for securing the corresponding rolling element 22 by countersunk screws.

In the same manner as in the aforesaid embodiment, this hinge 20 has a pair of the rolling elements 22 connected together by the connection plates 24a, and the slidingly engaging portions 23 are respectively formed between the contacting surfaces 2 lb of the movable piece 21 and the connection plates 24a. Accordingly, the movable piece 21 may be formed into not only a cubic shape and a rectangular solid shape, but also a trapezoidal shape with the opposite side surfaces 21a inwardly inclined and the opposite contacting surfaces 21b parallel to each other. Racks are formed on the opposite side surfaces 21a of the movable piece 21, and pinions are formed on the circumferences of the rolling sections 22a to be meshed with the racks. The slidingly engaging portions 23 each are formed by the projection strip 23a formed on each contacting surface 21b of the movable piece 21 and the groove 23 formed in the corresponding connection plate 24a. The slidingly engaging portions 23 each may be formed by the groove 23b formed in each contacting surface 21b of the movable piece 21 and the projection strip 23a formed on the corresponding connection plate 24a.

The thus structured hinges 20 may connect both the door panels 11, 12 together by securing the flanges 22f of the rolling elements 22 to the edges of the door panels 11, 12 to provide a bifold door, as mentioned above. Since the flange 22f of each rolling element 22 extends vertically relative to the support section 22g so that it can be easily secured to any frame member such as the vertical doorframe 1 and the upper doorframe 2.

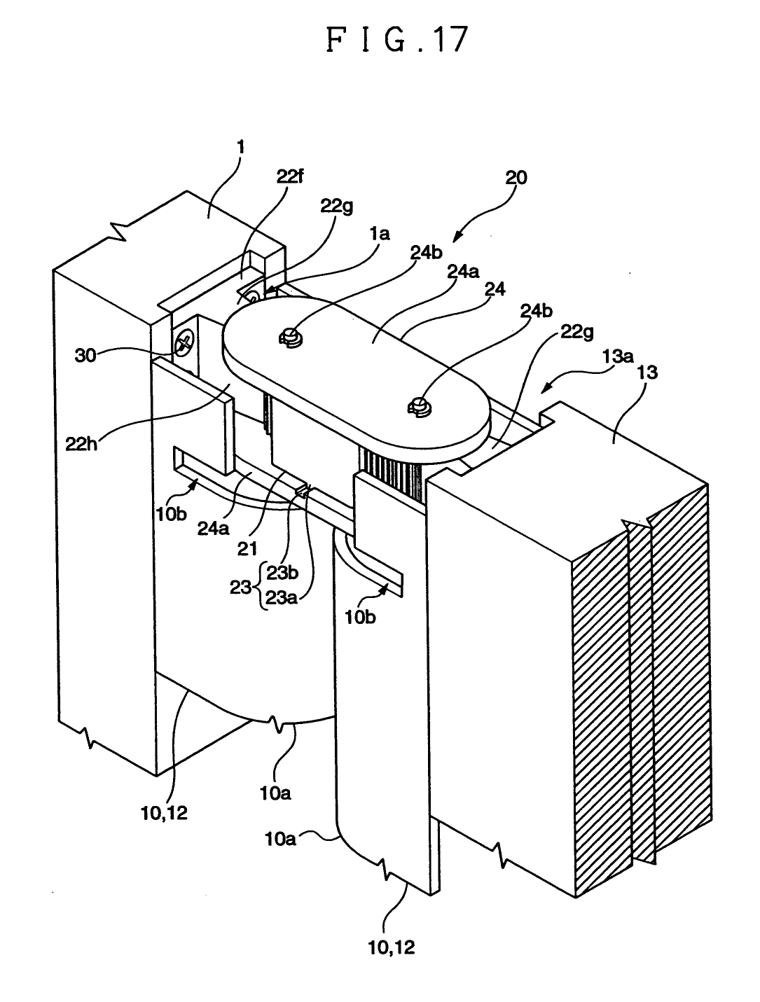

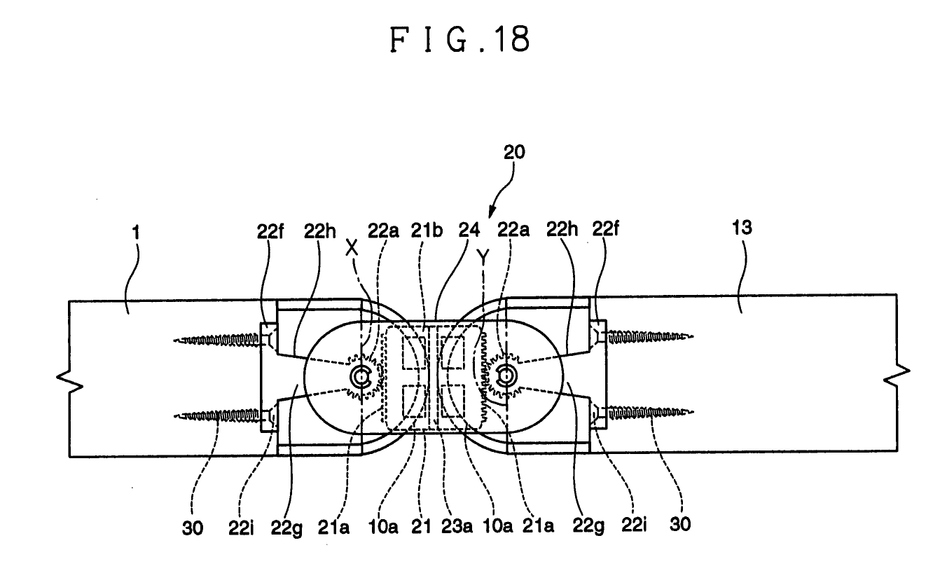

Accordingly, this hinge 20 may be provided in a door such as a swinging door with a single door panel 13 being swung in the opposite directions to a opening position and a closing position, as illustrated in FIGS. 17 to 22. Specifically, this hinge 20 is mounted so as to connect the door panel 13 to the vertical door frame 1. The abutting edges of both the vertical frame 1 and the door panel 13 respectively have cutouts 1a, 13a. The flanges 22f are respectively secured to the vertical doorframe 1 and the door panel 13 by the countersunk screws 30 so that the rolling elements 22 are embedded in the cutouts 1a, 13a. The cutouts 1a, 13a and the ribs 22h of the rolling elements 22 are so sized to have the edges of the vertical frame 1 and the door panel 13 aligned with the axes of the rolling section 22a of the rolling elements 22 along phantom lines X and Y when viewed in plan, as illustrated in FIG. 18. The semi-cylindrical covers 10a are respectively attached to the edges of the vertical frame 1 and the door panel 13.

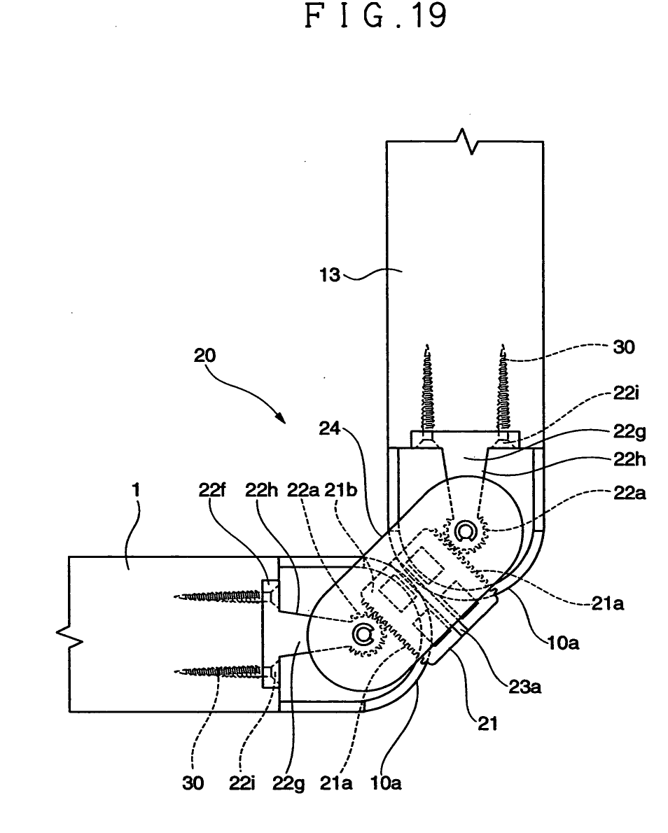

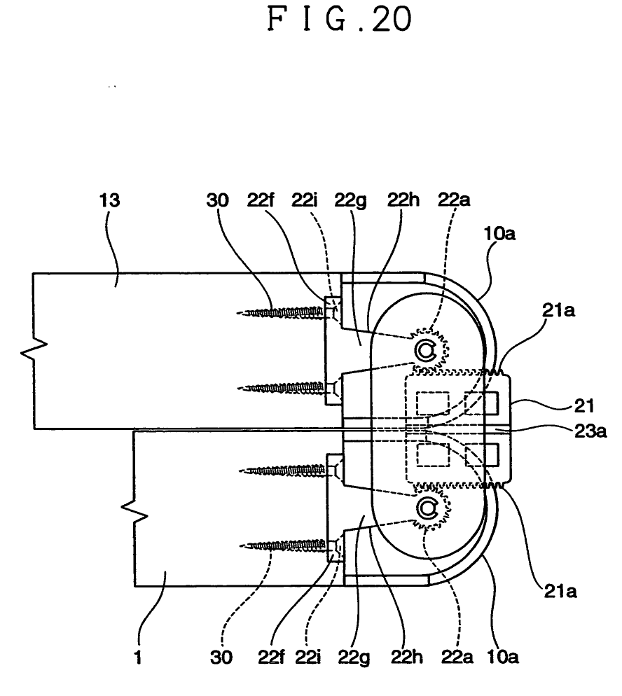

The door panel 13 has the pair of the rolling elements 22 aligned in a straight line, when they are held in a closed position, as illustrated in FIGS. 17 and 18. When the door panel 13 is pushed, it is a matter of course that the rolling element 22 secured to the vertical doorframe 1 is not moved, but as illustrated in FIG. 19, the movable piece 21 is moved around the rolling section 22a of this rolling element 22 and the other (second) rolling element 22 is moved via the movable piece 21. Thus, the door panel 13 is oriented 180 degrees opposite to the vertical door frame 1, so as to be brought into an opening as illustrated in FIG. 20.

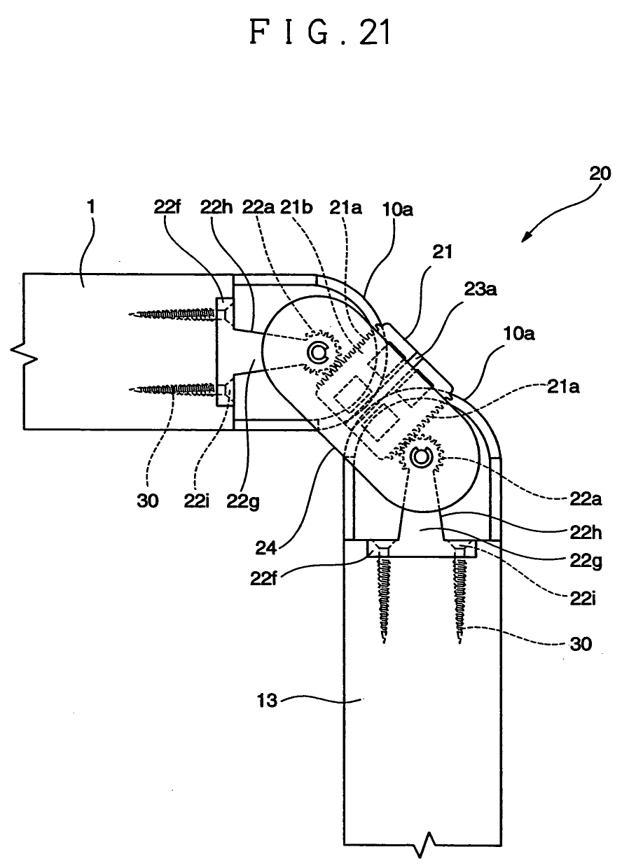

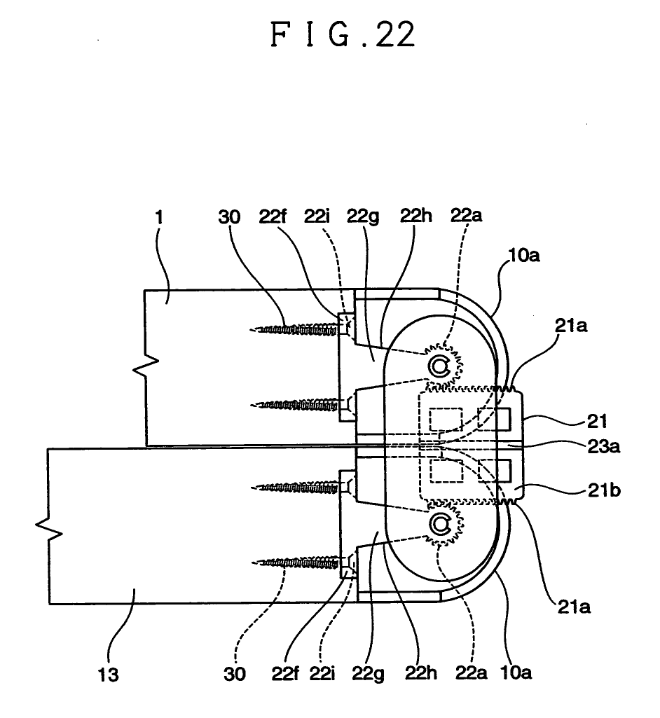

On the other hand, when the door panel 13 is pulled, the movable piece 21 and the second rolling element 22 are moved in the direction opposite to the direction in the aforesaid operation around the rolling section 22a of the rolling element 22 secured to the vertical doorframe 1, as illustrated in FIG. 21, so that the door panel 13 is moved in a direction opposite to the aforesaid operation and thus oriented 180 degrees opposite to the vertical doorframe 1 so as to be brought into an opening position, as illustrated in FIG. 22. Thus, the door panel 13 is moved 360 degrees around one of the rolling elements 22 (first rolling element 22) in the opposite directions.

According to the action of the hinge 20 in this swinging action of this door panel 13, when in the door closing position, the door panel 13 is pushed or pulled with the movable piece 21 held at an intermediate position between both the rolling elements 22, the rolling section 22a of the rolling element 22 secured to the door panel 13 is moved on the corresponding side surface 21a of the movable piece 21. Accordingly, the movable piece 21 is moved towards the first or second side, and at the same time, the movable piece 21 has the opposite side surface 21a sliding on the rolling section 22a of the rolling element 22 secured to the vertical doorframe 1, while being moved around this rolling section 22a.

For the hinges 20 mounted in this swinging door, the slidingly engaging portions 23 made up of the projection strips 23a and the grooves 23b, which serves as a buffer means, can prevent a large load from being applied to the movable piece 21 and the other (second) rolling element 22. As a result, the racks and the pinions are unlikely to be damaged even by repeated opening and closing of the door. Thus, the smooth opening and closing operation of this single door panel 13 in the opposite directions through the movement around 360 degrees can be secured for a prolonged period of time.

It is a matter of course that the present invention is not necessarily limited to the above embodiments and may be modified without departing from the intended scope of the present invention. For example, the opposite side surfaces 2 la of the movable piece 21 and the circumferences of the rolling section 22a in each hinge 20 may be made of a material having a large friction coefficient such as rubber, or may have rough surfaces, so that it is not necessary to form racks on the opposite side surfaces of the movable piece 21 and pinions on the circumferences of the rolling section 22a. Even this arrangement, the rolling elements may be able to roll on the opposite side surfaces of the movable piece 21 without slipping thanks to a large friction force.

The pins 24b passing through the connection plates 24a of the connection element 24 are not necessarily formed independently of each other. For example, it is possible to provide an upper pin member and a lower pin member, each having a U-shape with both ends passing the rotational axes from above and below through the connection plates 24a. Further, the hinge 20 may be formed by the combination of pentagonal rolling elements 22 taken for example in the embodiment in which the hinge 20 is used for a bifold door, and the T-shaped or L-shaped rolling elements 22 taken for example in the embodiment in which the hinge is used for a swinging door.

The hinge 20 may be mounted to various kinds of the panel bodies each forming a lid, a partition or the like, as well as the door panels 11, 12, 13.

This specification is by no means intended to restrict the present invention to the preferred embodiments set forth therein. Various modifications to the hinge and the hinge mounting door, as described herein, may be made by those skilled in the art without departing from the spirit and scope of the present invention as defined in the appended claims.

1: A hinge comprising:
a pair of rolling elements disposed with a distance therebetween;
a movable piece that has opposite side surfaces respectively facing the pair of rolling elements so that the pair of rolling elements respectively roll on the opposite side surfaces of the movable piece, thereby allowing the movable piece to be reciprocatingly moved; and
a connection element that connects the pair of rolling elements together, while allowing the same to roll.

2: The hinge according to claim 1, wherein the opposite side surfaces of the movable piece respectively form racks thereon, and the pair of rolling elements have pinions to be respectively meshed with the racks, so that the movable piece can be reciprocatingly moved by the meshed engagement between the racks and the pinions.

3: The hinge according to claim 1, wherein the connection element includes a pair of connection plates each having opposite ends protruding outwards from the opposite side surfaces of the movable piece and an intermediate portion between the opposite ends; the movable piece has plate contacting surfaces, wherein the pair of connection plates respectively contact the plate contacting surfaces of the movable piece through the intermediate portions; and a pair of pins for supporting the pair of rolling elements and connecting the pair connection plates together through the opposite ends thereof.

4: The hinge according to claim 1, wherein a slidingly engaging portion is formed between each of the plate contacting surfaces and a corresponding one of the connection plates.

5: The hinge according to claim 4, wherein the slidingly engaging portion is made up of at least one projection strip and at least one groove.

6: The hinge according to claim 1, wherein the pair of rolling elements each are made up of a rolling section that rolls on the movable piece, a support section provided at an end thereof with a corresponding one of the pair of rolling elements, and a flange formed at a proximal end of the support section, wherein the rolling section, the support section and the flange are integrally formed into a frame shape.

7: The hinge according to claim 1, wherein the pair of rolling elements each are made up of a rolling section that rolls on the movable piece, a pair of inclined plates extending in a substantially V-like shape with the rolling section serving as an apex thereof, a pair of mounting plates disposed parallel to each other with a distance being substantially equal to the length of each of the opposite side surfaces of the movable piece, wherein the rolling section, the pair of inclined plates and the pair of mounting plates are integrally formed into a frame shape.

8: A door comprising the hinge of claim 1, wherein the pair of rotating elements are respectively secured to door panels, or a door and a frame.

9: The door according to claim 8, wherein the connection element has a width substantially equal to or smaller than the door thickness.

10: The door according to claim 8, wherein a semi-cylindrical cover having a diameter substantially equal to the width of the pair of rolling elements is disposed on a side of the hinge so as to project towards the movable piece.

11: The door according to claim 8, wherein semi-cylindrical covers each having a diameter substantially equal to the width of the pair of rolling elements are disposed on the opposite sides of the hinge so as to project towards the movable piece.
